(19) United States
(12) Patent Application Publication
(10) Pub. No.: US 2016/0280979 A1
(43) Pub. Date: Sep. 29, 2016

(54) ADHESIVE RESIN COMPOSITION

(71) Applicant: ARISAWA MFG. CO., LTD., Niigata (JP)

(72) Inventors: Akira Uchiyama, Niigata (JP); Kazuo Yoshikawa, Niigata (JP); Makoto Tai, Niigata (JP); Nobuyuki Iwano, Niigata (JP)

(21) Appl. No.: 15/177,828

(22) Filed: Jun. 9, 2016

Related U.S. Application Data
(63) Continuation of application No. 13/903,722, filed on May 28, 2013.

(30) Foreign Application Priority Data
May 28, 2012 (JP) 2012-121259

(51) Int. Cl. C09J 175/14; B32B 7/12; B32B 15/092

(52) U.S. Cl. CPC C09J 175/14; B32B 15/092; B32B 7/12; B32B 2255/26

(57) ABSTRACT

A resin composition for a flexible printed circuit board that can attain high adhesiveness and solder reflow resistance even if a base film having low dielectric properties is used, and that attains excellent electrical properties. The resin comprises a fluororesin and an isocyanate compound, wherein the fluororesin has a content of 1 to 50% by mass, and a hydroxyl equivalent of 300 to 5500 g/equivalent.

### CROSS-REFERENCE TO RELATED APPLICATIONS

This application is a continuation of U.S. patent application Ser. No. 13/903,722, filed on May 28, 2013, which claims priority to and the benefit of Japanese Patent Application No. 2012-121259 filed on May 28, 2012, the entire content of which is incorporated herein by reference.

### FIELD

A resin composition for a flexible printed circuit board, and a coverlay film, a laminate, a resin coated copper foil, and a bonding sheet comprising the resin composition.

### BACKGROUND

A higher signal transmission rate of printed circuit boards leads to higher frequencies of signals in recent years. This increases a demand for a printed circuit board having low dielectric properties (low dielectric constant, low dielectric loss tangent) in a high frequency range. To meet such a demand, base films formed of a liquid crystal polymer (LCP), a syndiotactic polystyrene, and polyphenylene sulfide and having low dielectric properties are proposed as a base film used for the flexible printed circuit board (hereinafter, also referred to as the “FPC”) instead of the conventional polyimide films and polyethylene terephthalate films.

However, the base film having such low dielectric properties has low polarity. This low polarity results in a weak adhesive force in use of the conventional epoxy adhesive or acrylic adhesive, leading to difficulties to form an FPC member such as coverlay films and laminates.

As one of measures to solve the problem above, Japanese Patent Laid-Open No. 2004-352817 discloses a resin composition having improved adhesiveness to LCP.

The resin composition described in Japanese Patent Laid-Open No. 2004-352817 has insufficient heat resistance when moisture is absorbed. Further, the adhesiveness to SPS (syndiotactic polystyrene) or PPS (polyphenylene sulfide) is difficult to obtain.

Examples of adhesives having high adhesiveness to the base film having low dielectric properties include silicone resins. However, the silicone resin easily contaminates circuits in processing steps, resulting in low connection reliability.

A method without using an adhesive is used in use of the LCP base. In this method, the LCP is molten, and bonded to a copper foil to form a two-layer substrate. This method needs treatments at a high temperature in the bonding step. For this reason, the substrate easily wrinkles during processing, leading to reduction in yield.

Considering such circumstances, an embodiment of the invention provides a resin composition for a flexible printed circuit board that provides high adhesiveness and solder reflow resistance even if a base film having low dielectric properties is used, and attains excellent electrical properties.

### SUMMARY

As a result of extensive research to solve the problem above, it was found that a resin composition comprising a fluororesin and an isocyanate compound, and having a fluorine content and a hydroxyl equivalent of the fluororesin adjusted in specific ranges solves the problem above.

Namely, the invention is as follows.

[1]

A resin composition for a flexible printed circuit board comprising a fluororesin and an isocyanate compound,

wherein the fluororesin has a fluorine content of 1 to 50% by mass and a hydroxyl equivalent of 300 to 5500 g/equivalent.

[2]

The resin composition according to [1] above, wherein a carboxyl equivalent of the fluororesin is 1400 g/equivalent or more.

[3]

The resin composition according to [1] or [2] above, wherein the fluororesin has a weight average molecular weight of 5000 to 150000.

[4]

The resin composition according to any of [1] to [3] above, wherein the isocyanate compound is one or more selected from the group consisting of hexamethylene diisocyanate, tolylene diisocyanate, diphenylmethane diisocyanate, xylylene diisocyanate, isophorone diisocyanate, naphthalene diisocyanate, polyisocyanate, and a blocked isocyanate containing these isocyanates.

[5]

The resin composition according to any of [1] to [4] above, wherein the isocyanate compound contains 0.05 to 2.5 isocyanate groups based on one hydroxyl group in the fluororesin.

[6]

The resin composition according to any of [1] to [5] above, further comprising an epoxy resin.

[7]

The resin composition according to [6] above, wherein the resin composition contains 0.1 to 10 epoxy groups in the epoxy resin based on one carboxyl group in the fluororesin.

[8]

The resin composition according to [6] or [7] above, wherein the epoxy resin is one or more selected from the group consisting of bisphenol A epoxy resins, bisphenol F epoxy resins, bisphenol S epoxy resins, novolak epoxy resins, biphenyl epoxy resins, and cyclopentadiene epoxy resins.

[9]

The resin composition according to any of [1] to [8] above, further comprising an organic filler and/or an inorganic filler.

[10]

The resin composition according to [9] above, wherein the organic filler is one or more selected from the group consisting of organic phosphorus compounds, phosphazene compounds, and melamine, and the inorganic filler is one or more selected from the group consisting of aluminum hydroxide, magnesium hydroxide, and silica.

[11]

The resin composition according to [9] or [10] above, wherein a content of the organic filler and/or the inorganic filler is 0 to 100 parts by mass based on 100 parts by mass of the fluororesin.

[12]

A coverlay film, wherein an adhesive layer comprising the resin composition according to any of [1] to [11] above and a base film are laminated.

[13]

A single-sided copper-clad laminate, wherein an adhesive layer comprising the resin composition according to any of [1] to [11] above, a base film, and a copper foil are laminated, and

the base film is laminated on a first surface of the adhesive layer, and the copper foil is laminated on a second surface thereof.

[14]

A double-sided copper-clad laminate, wherein adhesive layer comprising the resin composition according to any of [1] to [11] above, a base film, and copper foils are laminated, and

the adhesive layers are laminated on both surfaces of the base film, and the copper foils are laminated on surfaces of the adhesive layers opposite to surfaces of the adhesive layers on which the base film is laminated.

[15]

The coverlay film or copper-clad laminate according to any of [12] to [14] above, wherein the base film contains one or more resins selected from the group consisting of polyimide, liquid crystal polymers, polyphenylene sulfide, syndiotactic polystyrene, polyethylene terephthalate, polyethylene naphthalate, polycarbonate, polybutylene terephthalate, polyether ether ketone, polyphenylene ether, and fluorine-based resins.

[16]

The coverlay film or copper-clad laminate according to [15] above, wherein the fluorine-based resin is one or more selected from the group consisting of polytetrafluoroethylene, polytetrafluoroethylene-perfluoroalkyl vinyl ether copolymers, tetrafluoroethylene-hexafluoropropylene copolymers, difluoroethylene-trifluoroethylene copolymers, tetrafluoroethylene-ethylene copolymers, polychlorotrifluoroethylene, and polyvinylidene fluoride.

[17]

A resin coated copper foil, wherein an adhesive layer comprising the resin composition according to any of [1] to [11] above, and a copper foil are laminated.

[18]

A bonding sheet comprising the resin composition according to any of [1] to [11] above.

The invention provides a resin composition for a flexible printed circuit board that provides high adhesiveness and solder reflow resistance even if a base film having low dielectric properties is used, and attains excellent electrical properties.

### DETAILED DESCRIPTION OF THE INVENTION

Hereinafter, an embodiment for implementing the invention will be described in detail. The invention is not limited to the embodiment below, and may be modified in various ways within the scope of the gist, and implemented.

The resin composition for a flexible printed circuit board according to an embodiment (hereinafter, also referred to as a “resin composition for an FPC”) is a resin composition for a flexible printed circuit board comprising a fluororesin and an isocyanate compound, wherein the fluororesin has a fluorine content of 1 to 50% by mass, and a hydroxyl equivalent of 300 to 5500 g/equivalent.

In the embodiment, the expression “resin composition for a flexible printed circuit board” designates the resin composition for a member for a flexible printed circuit board, and specifically designates the resin composition used in a coverlay film, a laminate (substrate), a resin coated copper foil, and a bonding sheet, for example.

The resin composition for an FPC according to the embodiment has high adhesiveness to liquid crystal polymers, syndiotactic polystyrene, polyphenylene sulfide, and the like having low dielectric properties, and has high solder reflow resistance. For this reason, coverlay films, laminates (substrates), and the like may be produced using a resin having low dielectric properties such as liquid crystal polymers, syndiotactic polystyrene, and polyphenylene sulfide as a base, in addition to the conventional polyimide and polyethylene terephthalate and the like.

The fluororesin in the embodiment is not particularly limited as long as the fluororesin is a resin having fluorine in the molecule structure, and examples thereof comprise resins (1) to (4) below:

(1) copolymers containing vinylidene fluoride, vinyl ether, and a vinyl monomer (the copolymers may further contain ethylene)
(2) copolymers containing ethylene trifluoride, vinyl ether, and a vinyl monomer (the copolymers may further contain ethylene)
(3) copolymers containing an ethylene tetrafluoride unit, vinyl ether, and a vinyl monomer (the copolymers may further contain ethylene)
(4) copolymers containing a propylene hexafluoride unit, vinyl ether, and a vinyl monomer (the copolymers may further contain ethylene)

The resins (1) to (4) may contain a halogen molecule in the skeleton.

Among these, copolymers containing ethylene tetrafluoride or propylene hexafluoride are preferred from the viewpoint of stability of bonding. The fluororesins may be used alone or in combinations of two or more.

Specific examples of the copolymer (2) include FLUONATE Series made by Dainippon Ink and Chemicals, Incorporated (such as K-700, K-702, K-704, K-705, and WQZ-660), and LUMIFLON Series made by Asahi Glass Co., Ltd. (such as LF200, LF400, LF600, LF600X, LF800, LF906N, LF910LM, LF916N, LF936, and LF9010).

Specific examples of the copolymer (3) include ZEFFLE Series made by Daikin Industries, Ltd. (such as GK-500, GK-510, GK-550, and GK-570).

The composition of the copolymer (4) preferably comprises 5 to 60 mol % of propylene hexafluoride, 19.5 to 55 mol % of vinyl ether, and 26 to 55 mol % of vinyl.

The fluororesin has a fluorine content of 1 to 50% by mass, preferably 3 to 45% by mass, and more preferably 5 to 40% by mass. A fluorine content of less than 1% by mass leads to inferior flame retardancy. At a fluorine content of more than 50% by mass, fluorine is contained at an excessively large ratio. Excessive fluorine causes releasing properties to inhibit a sufficient adhesive force.

The equivalent of a hydroxyl group in the fluororesin is 300 to 5500 g/equivalent, preferably 450 to 3500 g/equivalent, and more preferably 550 to 3000 g/equivalent. An equivalent of a hydroxyl group more than 5500 g/equivalent leads to low crosslinking density, and then significantly reduces solder heat resistance. At an equivalent of a hydroxyl group less than 300 g/equivalent, the hydroxyl group excessively remains. As a result, moisture absorbing properties and water absorbing properties are enhanced, leading to inferior solder heat resistance. Additionally, the fluororesin has many crosslinking points, and the fluororesin easily reacts even at normal temperature, leading to inferior storage stability.

The carboxyl equivalent of the fluororesin is preferably 1400 or more g/equivalent, more preferably 2800 or more g/equivalent, and still more preferably 3700 or more g/equivalent. At a carboxyl equivalent within the range above, the fluororesin tends to properly react with the isocyanate compound, providing higher properties such as an adhesive force and solder heat resistance. At a carboxyl equivalent of less than 1400 g/equivalent, the fluororesin has many crosslinking points. For this reason, the fluororesin may easily react even at normal temperature, leading to inferior storage stability.

The fluororesin has a weight average molecular weight of preferably 5000 to 150000, more preferably 10000 to 120000, and still more preferably 15000 to 100000. At a weight average molecular weight of 5000 or more, cissing tends to be difficult to produce during coating and drying, attaining more stable productivity. A weight average molecular weight of 150000 or less leads to higher fluidity. For this reason, higher anti-circuit-embedding properties tend to be attained, therefore improving reliability.

The weight average molecular weight is measured by gel permeation chromatography, and converted using a calibration curve produced using standard polystyrene.

The resin composition for an FPC according to the embodiment contains an isocyanate compound. The isocyanate compound reacts with the hydroxyl group contained in the fluororesin to increase the crosslinking density and provide properties such as a sufficient adhesive force and solder heat resistance.

The isocyanate compound is not particularly limited. Examples thereof include one or more selected from the group consisting of hexamethylene diisocyanate (HDI), tolylene diisocyanate (TDI), diphenylmethane diisocyanate (MDI), xylylene diisocyanate (XDI), isophorone diisocyanate (IPDI), naphthalene diisocyanate (NDI), polyisocyanate, and a blocked isocyanate containing these isocyanates. Among these, hexamethylene diisocyanate is preferred from the viewpoint of flexibility. The isocyanate compounds may be used alone or in combinations of two or more.

For the content of the isocyanate compound, the resin composition contains preferably 0.05 to 2.5, more preferably 0.1 to 2.0, and still more preferably 0.15 to 1.5 isocyanate groups in the isocyanate compound based on one hydroxyl group in the fluororesin. If the resin composition contains 0.05 or more isocyanate groups in the isocyanate compound based on one hydroxyl group in the fluororesin, high reactivity is attained. This tends to result in a higher adhesive force and solder heat resistance. If the resin composition contains 2.5 or less isocyanate groups in the isocyanate compound based on one hydroxyl group in the fluororesin, the isocyanate group does not excessively react with the hydroxyl group, providing high storage stability. Additionally, a risk of gelation of an adhesive varnish before coating tends to reduce.

The resin composition for an FPC according to the embodiment may further contain an epoxy resin. If the fluororesin contains a carboxyl group, the carboxyl group reacts with the epoxy resin to increase the crosslinking density. As a result, higher properties such as the adhesive force and solder heat resistance tend to be provided.

The epoxy resin is not particularly limited, and examples thereof include one or more selected from the group consisting of bisphenol A epoxy resins, bisphenol F epoxy resins, bisphenol S epoxy resins, novolak epoxy resins, biphenyl epoxy resins, alicyclic epoxy resins, and dicyclopentadiene epoxy resins. Among these, dicyclopentadiene epoxy resins are preferred from the viewpoint of dielectric properties. These epoxy resins may be used alone or in combinations of two or more.

For the content of the epoxy resin, the resin composition contains preferably 0.1 to 10, more preferably 0.2 to 7, and still more preferably 0.3 to 4 epoxy groups in the epoxy resin based on one carboxyl group in the fluororesin. If the resin composition contains 0.1 or more epoxy groups in the epoxy resin based on one carboxyl group in the fluororesin, higher reactivity is attained. This tends to lead to a higher adhesive force and solder heat resistance. If the resin composition contains 10 or less epoxy groups in the epoxy resin based on one carboxyl group in the fluororesin, the epoxy resin is not excessively left. This tends to lead to higher insulation reliability.

From the viewpoint of improving flame retardancy, the resin composition for an FPC according to the embodiment may further contain an organic filler and/or an inorganic filler.

The organic filler is not particularly limited, and examples thereof include one or more selected from the group consisting of organic phosphorus compounds, phosphazene compounds, and melamine. Among these, organic phosphorus compounds are preferred from the viewpoint of flame retardancy. The inorganic filler is not particularly limited, and examples thereof include one or more selected from the group consisting of aluminum hydroxide, magnesium hydroxide, and silica. Among these, aluminum hydroxide is preferred from the viewpoint of flame retardancy.

These organic fillers and/or inorganic fillers may be used alone or in combinations of two or more.

The content of the organic filler and/or inorganic filler is preferably 0 to 100 parts by mass, more preferably 1 to 70 parts by mass, and still more preferably 2 to 50 parts by mass based on 100 parts by mass of the fluororesin. At a content of the organic filler and/or inorganic filler within the range above, the effect of improving flame retardancy tends to sufficiently demonstrate without reducing the aggregation force of the resin composition.

In addition to the isocyanate compounds above, as the compound to be reacted with the hydroxyl group in the fluororesin, the resin composition may comprise acid anhydrides, resol phenol resins, and melamine resins containing a hydroxyalkyl group such as a methylol group.

Examples of the acid anhydrides include trimellitic anhydride (TMA), pyromellitic dianhydride (PMDA), benzophenone tetracarboxylic dianhydride (BTDA), tetrahydrophthalic anhydride (THPA), hexahydrophthalic anhydride (HHPA), methyl hexahydrophthalic anhydride (MHHPA), methyl tetrahydrophthalic anhydride (MTHPA), methyl nadic anhydride (MNA), dodecenyl succinic anhydride (DDSA), phthalic anhydride, and chlorendic anhydride.

The resin composition for an FPC according to the embodiment may contain other additives besides the components described above. As the other additives, a variety of known additives such as hindered phenol antioxidants, phosphorus antioxidants, and sulfur antioxidants; stabilizers such as light stabilizers, weathering stabilizers, and heat stabilizers; flame retardants such as triallyl phosphate and phosphoric acid ester; anionic, cationic, and nonionic surfactants; plasticizers; and lubricants may be used, for example. The amounts of the additives blended may be properly controlled according to the purpose in the range in which the effect of the invention is not impaired.

The resin composition for an FPC according to the embodiment may be used as an adhesive for a variety of members for an FPC. Hereinafter, the members for an FPC will be described.

The coverlay film according to the embodiment has a structure in which an adhesive layer comprising the resin composition for an FPC and a base film are laminated.

The base film plays a role in protecting a circuit and the like formed on a circuit board when the coverlay film is used as a member for an FPC. The base film is not particularly limited. Examples of the base film include one or more resins selected from the group consisting of polyimide, liquid crystal polymers, polyphenylene sulfide, syndiotactic polystyrene, polyethylene terephthalate, polyethylene naphthalate, polycarbonate, polybutylene terephthalate, polyether ether ketone, and fluorine-based resins. Particularly, advantageously, the resin composition for an FPC according to the embodiment demonstrates high adhesiveness to a resin having low polarity such as liquid crystal polymers, polyphenylene sulfide, and syndiotactic polystyrene.

The fluorine-based resin used as the base film is not particularly limited. Examples of the fluorine-based resin include one or more selected from the group consisting of polytetrafluoroethylene, polytetrafluoroethylene-perfluoroalkyl vinyl ether copolymers, tetrafluoroethylene-hexafluoropropylene copolymers, difluoroethylene-trifluoroethylene copolymers, tetrafluoroethylene-ethylene copolymers, polychlorotrifluoroethylene, and polyvinylidene fluoride.

The single-sided copper-clad laminate according to the embodiment is a laminate, wherein an adhesive layer comprising the resin composition for an FPC, a base film, and a copper foil are laminated, and has a structure in which the base film is laminated on the first surface of the adhesive layer, and the copper foil is laminated on the second surface thereof.

The double-sided copper-clad laminate according to the embodiment is a laminate, wherein adhesive layers comprising the resin composition for an FPC, a base film, and copper foils are laminated, and has a structure in which the adhesive layers are laminated on both surfaces of the base film, and the copper foils are laminated on the surfaces opposite to the surfaces of the adhesive layers on which the base film is laminated.

The double-sided copper-clad laminate has a structure in which one adhesive layer and one copper foil are further provided on one of the surfaces of the base film in the single-sided copper-clad laminate opposite to the surface on which another adhesive layer and another copper foil are laminated. Hereinafter, the single-sided copper-clad laminate and the double-sided copper-clad laminate are also referred to as the “laminate” collectively.

The adhesive layer in the laminate has a curing state different from that of the adhesive layer in the coverlay film. Specifically, the adhesive layer contained in the coverlay film is in B-stage as the curing state while the adhesive layer contained in the laminate is in C-stage as the curing state. The coverlay film is bonded to the laminate having a circuit formed thereon, and then the adhesive layer in the coverlay film is cured to C-stage, as described later.

The adhesive layer contained in the laminate has a thickness of preferably 5 to 50 μm, and more preferably 10 to 25 μm. At a thickness of the adhesive layer of 5 μm or more, higher adhesiveness between the base film and an adherent tends to be provided. At a thickness of 50 μm or less, higher folding properties tend to be provided.

The resin coated copper foil according to the embodiment has a structure in which the adhesive layer comprising the resin composition for an FPC and a copper foil are laminated.

The bonding sheet according to the embodiment comprises the resin composition for an FPC, and may be obtained by molding the resin composition for an FPC into a sheet-like form.

Use of the resin coated copper foil and the bonding sheet above enables multi-layered FPCs.

The variety of members above may further have a separate film on a surface in which the adhesive layer is exposed.

The resin for forming the separate film is not particularly limited. Examples of the resin include one or more resins selected from the group consisting of polyethylene terephthalate resins, polyethylene naphthalate resins, polypropylene resins, polyethylene resins, and polybutylene terephthalate resins. Among these, one or more resins selected from the group consisting of polypropylene resins, polyethylene resins, and polyethylene terephthalate resins are preferred from the viewpoint of reducing production cost.

In use of a variety of members having the separate film, the separate film is peeled off, and then the surface of the adhesive layer is bonded to an adherend.

The flexible printed circuit board comprises the coverlay film and the laminate above. The flexible printed circuit board is obtained by forming a circuit in the copper foil comprised in the laminate, and then bonding the adhesive layer in the coverlay film to the circuit formed surface of the laminate.

A method of producing a variety of members according to the embodiment is not particularly limited, and a known method may be used.

The coverlay film according to the embodiment may be produced by, for example, the method comprising the step (a) below:

(a) a step of applying a varnish of the resin composition for an FPC for forming an adhesive layer to one surface of the base film, and drying the varnish to B-stage.

The method of producing a single-sided copper-clad laminate according to the embodiment performs the step (a), and further the step (b) below, for example:

(b) a step of heat pressing a copper foil to the surface of the adhesive layer provided on the coverlay film obtained in the step (a), and drying the adhesive layer to C-stage.

The double-sided copper-clad laminate according to the embodiment may be produced by a method in which an adhesive layer and a copper foil are laminated on the other surface of the base film in the single-sided copper-clad laminate by the same method as above.

The resin coated copper foil according to the embodiment may be produced, for example, by the method comprising the step (c) below:

(c) a step of applying a varnish of the resin composition for an FPC for forming an adhesive layer to one surface of the copper foil, and drying the varnish to B-stage.

When the variety of members includes a separate film, the production method further comprises, for example, the step (d) below:

(d) a step of bonding a separate film to a surface in which an adhesive layer is exposed in a variety of members, the separate film and the member facing each other.

Examples of a solvent used for the varnish include acetone, toluene, methyl ethyl ketone, methyl isobutyl ketone, cyclohexanone, propylene glycol monomethyl ether, dimethylacetamide, butyl acetate, and ethyl acetate.

As a method of applying a varnish, a comma coater, a die coater, a gravure coater, and the like may be properly used according to the thickness of the varnish to be applied.

The varnish may be dried with an in-line dryer and the like. The drying condition at this time may be properly adjusted according to the kinds of resins and additives and the amounts thereof, for example.

Herein, the physical properties may be measured and evaluated according to the methods described in Examples below, unless otherwise specified.

### EXAMPLES

Hereinafter, the invention will be more specifically described using Examples and Comparative Examples, but the invention will not be limited to only these Examples.

In Examples and Comparative Examples, the physical properties were measured and evaluated according to the methods below.

### Hydroxyl Equivalent

The hydroxyl equivalent was measured according to JIS K 1557-1. Specifically, the measurement was performed as follows.

10 mL of an acetic anhydride solution (prepared using 400 mL of ethyl acetate, 4 g of perchloric acid, and 50 mL of acetic anhydride) was added to 3 g of a sample, and stirred for 15 minutes. 2 mL of water and 10 mL of a pyridine aqueous solution (prepared using 300 mL of pyridine and 100 mL of water) were added to the solution, and the solution was stirred for 5 minutes. Subsequently, 10 mL of the pyridine aqueous solution was further added.

The obtained solution was titrated with an ethanol solution of 0.5 mol/L potassium hydroxide, and the hydroxyl equivalent was calculated by the following calculation expression:

hydroxyl equivalent(g/equivalent)=(56100×3 (g/amount sampled))/((56.1542(mL/blank value)−(amount titrated mL))×28.05(concentration conversion coefficient))

### Carboxyl Equivalent

The carboxyl equivalent was measured according to JIS K 1557-5. Specifically, the measurement was performed as follows.

200 mL of 2-propanol, 100 mL of water, and 7 drops of a methanol solution of bromothymol blue were added. The obtained solution was titrated with a methanol solution of 0.02 mol/L potassium hydroxide until the obtained solution became green. 50 g of the sample was dissolved in the green solution.

The resulting solution was titrated with a methanol solution of 0.02 mol/L potassium hydroxide, and the carboxyl equivalent was calculated by the following calculation expression:

carboxyl equivalent(g/equivalent)=(56100×3 (g/amount sampled)/((1.122×(amount titrated mL)×0.02 (concentration of titration solution))

### Fluorine Content

The fluorine content was measured by ion chromatography using quartz tube combustion method according to JAB Testing RTL03170, JAB being a test organization certificated by ISO/IEC17025.

Decomposition: quartz tube combustion method

Quartz tube: “AQF-100” made by Mitsubishi Chemical Analytech Co., Ltd.

Furnace inner temperature: 900±5° C. on the IN side, 1000±5° C. on the OUT side

Absorbent: 1 mL of eluent raw solution, 5 mL of sodium tartrate, 50 μL of 30% hydrogen peroxide solution, and 500 mL of ultrapure water

Quantification: ion chromatography (JIS K0127)

Apparatus: “DX-120” made by Dionex Corporation

Column: “AS12A” made by Dionex Corporation

Suppressor: “ASRS-300” made by Dionex Corporation Peel Strength

### (1) Procedure of Producing Sample

The resin composition for an FPC was applied to each of various base films, and cured and dried to a semi-curing state (B-stage) on the condition of 150° C. and 5 minutes such that the thickness after drying was 25 μm.

Next, the resin composition coated surface was bonded to a rough surface of a rolled copper foil (made by JX Nippon Mining & Metals Corporation, product name BHY-22B-T, thickness of 35 μm). The bonded product was heat pressed at 160° C. for 2 hours to obtain a single-sided copper-clad laminate.

### (2) Measurement Method

Using an Autograph AGS-500 made by Shimadzu Corporation, the peel strength in the direction of 90° was measured, and evaluated as follows. The base film was pulled, and the test speed was 50 mm/min.

⊚: peel strength is 8 N/cm or more
◯: peel strength is not less than 5 N/cm and less than 8 N/cm
X: peel strength is less than 5 N/cm

### Solder Reflow Resistance

### (1) Procedure of Producing Sample

(i) The resin composition for an FPC was applied to each of various base films, and cured and dried to a semi-curing state (B-stage) on the condition of 150° C. and 5 minutes such that the thickness after drying was 25

(ii) The resin composition coated surface was bonded to a rough surface of a rolled copper foil (made by JX Nippon Mining & Metals Corporation, product name BHY-22B-T, thickness of 35 μm). The bonded product was heat pressed at 160° C. for 2 hours to obtain a single-sided copper-clad laminate.

(iii) Another product having the same configuration as that of the product produced in (i) above was prepared. The resin composition coated surface was bonded to the gloss surface of the copper foil in the single-sided copper-clad laminate produced by the same procedure as that in (ii) above. The bonded product was heat pressed at 160° C. and 1 hour to produce a sample for evaluation of solder reflow resistance. In the evaluation, the sample cut into a size of 50 mm×50 mm was used.

### (2) Sample Used in Evaluation

A non-treated sample and a treated sample preserved on the condition of 40° C. and 90% RH for 96 hours were used.

### (3) Measurement Method

The peak temperature in a solder reflow furnace was set at 260° C. The furnace was adjusted to have a traveling rate of 300 ram/min and the exposure time at the peak temperature of 10 seconds. The non-treated sample and the treated sample each were fed into the furnace.

The samples were evaluated by visually observing whether the sample having passed through the reflow furnace had swell or peel-off.

◯: no swell or peel-off was found.
X: swell or peel-off was found.

### Varnish Life Properties

### (1) About Varnish

A varnish was prepared by sufficiently stirring each of the resin compositions for an FPC in Examples and Comparative Examples.

### (2) Evaluation of Varnish Life

The state of the varnish after preserved on the condition of 25° C. and 50% RH for 3 days was visually observed, and evaluated as follows:

◯: gelation of the varnish was not found.
X: the varnish was partially gelated.

### Product Life Properties

### (1) Production of Sample

The resin composition for an FPC was applied to each of various base films, and cured and dried to a semi-curing state (B-stage) on the condition of 150° C. and 5 minutes such that the thickness after drying was 25 Next, the resin composition coated surface and the releasing-treated surface of a PET layer substrate having one releasing-treated surface (releasing film) were laminated to obtain a sample.

### (2) Production of Adherent

An adherent used was a two-layer substrate comprising a rolled copper foil (made by JX Nippon Mining & Metals Corporation, thickness of 35 μm) and a polyimide layer having a thickness of 25 μm and formed on a rough surface of the copper foil, in which a circuit pattern at L/S=100/100 was formed on the gloss surface of the copper foil in the two-layer substrate.

### (3) Evaluation Method

A sample immediately after production and a sample preserved on the condition of 5° C. for 3 months were evaluated. In the evaluation method, the resin composition coated surface of the sample after the releasing film was removed was bonded to the circuit forming surface of the adherent, and the bonded product was pressed. The surface and cross section of the sample after pressing were observed visually and with an optical microscope to check whether the sample had voids or swellings, and evaluated as follows. The pressing was performed on the condition of 160° C., 1 hour, and 3 MPa.

◯: no voids or swellings are found in both of the samples.
X: voids or swellings are found in at least one of the samples.

### Insulation Reliability

### (1) Production of Sample

The same sample as that produced in [Product life properties] was used. In use, the releasing film was removed, and measurement was performed.

### (2) Production of Adherent

An adherent used was a two-layer substrate comprising an electrodeposited copper foil (made by JX Nippon Mining & Metals Corporation, thickness of 18 μm) and a polyimide layer having a thickness of 25 μm and formed on the rough surface of the copper foil in which a circuit pattern at L/S=50/50 was formed on the gloss surface of the copper foil in the two-layer substrate.

### (3) Evaluation Method

In the evaluation method, the releasing film was removed from the sample. The resin composition coated surface was bonded to the circuit forming surface of the adherent by pressing. The insulation reliability of the sample after pressing was evaluated. The evaluation was made by checking presence of short circuit after 1000 hours on the condition of 85° C., 85% RH, and DC of 50 V. The pressing was performed on the condition of 160° C., 1 hour, and 3 MPa.

◯: no short circuit occurs even after 1000 hours have passed.
X: short circuit occurs before 1000 hours have passed.

### Flame Retardancy

### (1) Procedure of Producing Sample

The resin composition for an FPC was applied to each of various base films, and cured and dried to a semi-curing state (B-stage) on the condition of 150° C. and 5 minutes such that the thickness after drying was 25 The same base film was heat pressed to the resin composition coated surface on the condition of 160° C. and 1 hour to obtain a sample.

### (2) Method of Evaluating Flame Retardancy

Flame retardancy was measured according to UL94, and evaluated as follows:

◯: the sample passed the VTM-0 test.
X: the sample was not able to pass the VTM-0 test.

### Dielectric Constant and Dielectric Loss Tangent]

### (1) Production of Sample

The same sample as that produced in [Product life properties] was used. In use, the releasing film was removed, and the measurement was performed.

### (2) Measurement Method

Using a Network Analyzer N5230A SPDR made by Agilent Technologies, Inc. (resonance method), the dielectric constant and dielectric loss tangent were measured under an atmosphere at 23° C. on the condition of a frequency of 5 GHz, and evaluated as follows.

dielectric constant
⊚: less than 3.0
◯: not less than 3.0 and less than 3.2
X: not less than 3.2
dielectric loss tangent
⊚: less than 0.015
◯: not less than 0.015 and less than 0.02
X: not less than 0.02

### Water Absorption

### (1) Production of Sample

The same sample as that produced in [Product life properties] was used. In use, the releasing film was removed, and measurement was performed.

### (2) Measurement Method

The sample was dried on the condition of 105° C. and 0.5 hours, and cooled to room temperature. The mass of the sample at this time was defined as an initial value (m0). The sample was immersed in pure water at 23° C. for 24 hours, and then the mass (md) was measured. From change between the initial value and the mass after immersion, the water absorption was measured using the following expression:

(md−m0)×100/m0=water absorption (%)

⊚: the water absorption is less than 1.
◯: the water absorption is not less than 1 and less than 1.5.
X: the water absorption is not less than 1.5.

### Production of Fluororesin

### Production Example 1

340 parts by mass of butyl acetate, 132 parts by mass of vinyl pivalate, 62 parts by mass of hydroxybutyl vinyl ether, 36 parts by mass of ethyl vinyl ether, 2 parts by mass of crotonic acid, and 7 parts by mass of diisopropyl peroxydicarbonate were charged into a 1000 mL stainless steel autoclave, and cooling was performed to 0° C. Then, degassing was performed under reduced pressure. 30 parts by mass of hexafluoropropylene was charged into the obtained mixture. The mixture was heated to 40° C. under stirring to make a reaction for 24 hours. The reaction was stopped when the reactor internal pressure reduced from 5 kg/cm² to 2 kg/cm². Thus, Fluororesin Al was obtained.

The obtained Fluororesin Al was analyzed by 19F-NMR, 1H-NMR, and a combustion method. Fluororesin Al was a copolymer composed of 11.1 mol % of a hexafluoropropylene unit, 21.9 mol % of an ethyl vinyl ether unit, 44.0 mol % of a vinyl pivalate unit, 22.0 mol % of a hydroxybutyl vinyl ether unit, and 1.0 mol % of a crotonic acid unit. The fluorine content was 10% by mass, the hydroxyl equivalent was 570 g/equivalent, and the carboxyl equivalent was 14,025 g/equivalent.

### Production Examples 2 to 6

### Comparative Production Examples 1 to 5

Fluororesins A2 to A6 and B1 to B5 were obtained by the same method as that in Example 1 except that the amount of the monomer to be charged was changed.

The compositions, fluorine content, hydroxyl equivalents, and carboxyl equivalents of the obtained fluororesins are shown in Table 1.

TABLE 1

| | | Production Examples | | | | | |
|---|---|---|---|---|---|---|---|
| | | 1 | 2 | 3 | 4 | 5 | 6 |
| Fluororesin | | A1 | A2 | A3 | A4 | A5 | A6 |
| composition | Chlorotrifluoroethylene | | | | | | |
| (mol %) | Hexafluoropropylene | 11.1 | 33.4 | 43.3 | 47.4 | 43.8 | 40 |
| | Ethyl vinyl ether | 21.9 | 16.4 | 14.4 | 15.8 | 14.5 | 13.2 |
| | Vinyl pivalate | 44 | 32.8 | 28.8 | 31.6 | 29 | 26.6 |
| | Hydroxybutyl vinyl ether | 22 | 16.4 | 12.5 | 4.2 | 12.7 | 13.2 |
| | Crotonic acid | 1 | 1 | 1 | 1 | 0 | 7 |
| | Fluorine content (mass %) | 10 | 30 | 39 | 42 | 40 | 36 |
| | Hydroxyl equivalent (g/equiv.) | 570 | 765 | 1,000 | 3,000 | 990 | 950 |
| | Carboxyl equivalent (g/equiv.) | 14,025 | 14,025 | 14,025 | 14,025 | — | 2,000 |

| | | Comparative Production Examples | | | | |
|---|---|---|---|---|---|---|
| | | 1 | 2 | 3 | 4 | 5 |
| Fluororesin | | B1 | B2 | B3 | B4 | B5 |
| composition | Chlorotrifluoroethylene | 0.8 | | | | |
| (mol %) | Hexafluoropropylene | | 66.8 | 31.4 | 48.6 | 37.8 |
| | Ethyl vinyl ether | 24.6 | 8.3 | 10.8 | 16.7 | 14.0 |
| | Vinyl pivalate | 49.1 | 15.6 | 20.8 | 31.2 | 25.4 |
| | Hydroxybutyl vinyl ether | 24.5 | 8.3 | 36.0 | 2.5 | 12.8 |
| | Crotonic acid | 1.0 | 1.0 | 1.0 | 1.0 | 10.0 |
| | Fluorine content (mass %) | 0.5 | 60.0 | 28 | 44 | 33 |
| | Hydroxyl equivalent (g/equiv.) | 513 | 1,512 | 280 | 5,600 | 951 |
| | Carboxyl equivalent (g/equiv.) | 14,025 | 14,025 | 14,025 | 14,025 | 1,300 |

### Production of Resin Composition for FPC)

The base films shown below were used in Examples and Comparative Examples:

liquid crystal polymer film (LCP) (made by Kuraray Co., Ltd., VECSTAR, thickness of 25 μm),

syndiotactic polystyrene (SPS) (made by Idemitsu Kosan Co. Ltd. XAREC, thickness of 25 μm), and

polyphenylene sulfide (PPS) (made by Toray Industries, Inc., TORELINA, thickness of 25 μm).

### Example 1

11 parts by mass (0.3 isocyanate groups based on one hydroxyl group in the fluororesin) of a commercially available HDI isocyanate resin (CORONATE 2770, made by Nippon Polyurethane Industry Co., Ltd.) was added to 100 parts by mass of Fluororesin Al obtained in Production Example 1, and 6 parts by mass (3 epoxy groups based on one carboxyl group in the fluororesin) of a commercially available dicyclopentadiene epoxy resin (HP7200, made by DIC Corporation) was added. Further, 30 parts by mass of a commercially available flame-retardant filler (0P930, made by Clariant International Ltd.) and 70 parts by mass of methyl ethyl ketone as a dispersion solvent were added. The mixture was stirred to obtain a resin composition for an FPC. Using the obtained resin composition, a variety of evaluations was performed. The results are shown in Table 2.

### Examples 2 to 9

### Comparative Examples 1 to 4, and Reference Examples 1 to 5

FPC resin compositions were obtained by the same method as that in Example 1 except that the kinds of fluororesins contained in the resin composition and the content of the components were changed as shown in Table 2. Using the obtained resin compositions, a variety of evaluations were performed. The results are shown in Tables 2 and 3.

TABLE 2

| | | Examples | | | | | | | | |
|---|---|---|---|---|---|---|---|---|---|---|
| | | 1 | 2 | 3 | 4 | 5 | 6 | 7 | 8 | 9 |
| (A) Fluororesin | Parts by mass | 100 | 100 | 100 | 100 | 100 | 100 | 100 | 100 | 100 |
| | Kind | A1 | A1 | A1 | A2 | A3 | A4 | A5 | A6 | A6 |
| (B) Isocyanate compound | Parts by mass | 11 | 11 | 11 | 9 | 7 | 2 | 7 | 7 | 7 |
| | Isocyanate groups/hydroxyl | 0.3 | 0.3 | 0.3 | 0.3 | 0.3 | 0.3 | 0.3 | 0.3 | 0.3 |
| | group | | | | | | | | | |
| (C) Epoxy resin | Parts by mass | 6 | 6 | 6 | 6 | 6 | 6 | — | 39 | 39 |
| | Epoxy groups/carboxyl group | 3 | 3 | 3 | 3 | 3 | 3 | — | 3 | 3 |
| (D)Filler | Parts by mass | 30 | 30 | 30 | 30 | 30 | 30 | 30 | 30 | — |
| Base film | | LPC | SPS | PPS | PPS | PPS | PPS | PPS | PPS | PPS |
| Peel strength | | ⊚ | ⊚ | ⊚ | ⊚ | ⊚ | ⊚ | ⊚ | ⊚ | ⊚ |
| Solder reflow resistance | Not treated | ◯ | ◯ | ◯ | ◯ | ◯ | ◯ | ◯ | ◯ | ◯ |
| | Treated at 40° C., 90%, and 96 hr | ◯ | ◯ | ◯ | ◯ | ◯ | ◯ | ◯ | ◯ | ◯ |
| Varnish life properties | | ◯ | ◯ | ◯ | ◯ | ◯ | ◯ | ◯ | ◯ | ◯ |
| Product life properties | | ◯ | ◯ | ◯ | ◯ | ◯ | ◯ | ◯ | ◯ | ◯ |
| Insulation reliability | | ◯ | ◯ | ◯ | ◯ | ◯ | ◯ | ◯ | ◯ | ◯ |
| Flame retardancy | | ◯ | ◯ | ◯ | ◯ | ◯ | ◯ | ◯ | ◯ | ◯ |
| Dielectric constant | | ⊚ | ⊚ | ⊚ | ⊚ | ⊚ | ⊚ | ⊚ | ⊚ | ⊚ |
| Dielectric loss tangent | | ⊚ | ⊚ | ⊚ | ⊚ | ⊚ | ⊚ | ⊚ | ⊚ | ⊚ |
| Water absorption | | ⊚ | ⊚ | ⊚ | ⊚ | ⊚ | ⊚ | ⊚ | ⊚ | ⊚ |

TABLE 3

| | | Comparative Examples | | | | Reference Examples | | | | |
|---|---|---|---|---|---|---|---|---|---|---|
| | | 1 | 2 | 3 | 4 | 1 | 2 | 3 | 4 | 5 |
| (A) Fluororesin | Parts by mass | 100 | 100 | 100 | 100 | 100 | 100 | 100 | 100 | 100 |
| | Kind | B1 | B2 | B3 | B4 | B5 | A6 | A6 | A6 | A6 |
| (B) Isocyanate compound | Parts by mass | 13 | 4 | 23 | 1 | 7 | 7 | 7 | 7 | 7 |
| | Isocyanate groups/hydroxyl | 0.3 | 0.3 | 0.3 | 0.3 | 0.3 | 0.02 | 3.0 | 0.3 | 0.3 |
| | group | | | | | | | | | |
| (C)Epoxy resin | Parts by mass | 6 | 6 | 6 | 6 | 60 | 39 | 39 | 39 | 39 |
| | Epoxy groups/carboxyl group | 3 | 3 | 3 | 3 | 3 | 3 | 3 | 15 | 3 |
| (D) Filler | Parts by mass | 30 | 30 | 30 | 30 | 30 | 30 | 30 | 30 | 150 |
| Base film | | PPS | | | | | | | | |
| Peel strength | | ⊚ | X | ◯ | ◯ | ◯ | ◯ | ◯ | ◯ | X |
| Solder reflow resistance | Not treated | ◯ | X | ◯ | X | ◯ | X | ◯ | ◯ | ◯ |
| | Treated at 40° C., 90%, and 96 hr | ◯ | X | X | X | ◯ | X | ◯ | ◯ | ◯ |
| Varnish life properties | | ◯ | ◯ | ◯ | ◯ | ◯ | ◯ | X | ◯ | ◯ |
| Product life properties | | ◯ | ◯ | X | ◯ | X | ◯ | ◯ | ◯ | X |
| Insulation reliability | | ◯ | ◯ | ◯ | ◯ | ◯ | ◯ | ◯ | X | ◯ |
| Flame retardancy | | X | ◯ | ◯ | ◯ | ◯ | ◯ | ◯ | ◯ | ◯ |
| Dielectric constant | | X | ⊚ | ◯ | ⊚ | X | ◯ | X | X | ⊚ |
| Dielectric loss tangent | | X | ⊚ | ◯ | ⊚ | X | ◯ | X | X | ⊚ |
| Water absorption | | ◯ | ⊚ | X | ⊚ | ◯ | ◯ | ◯ | ◯ | ◯ |

From the results shown in Tables 2 and 3, it turns out that the resin compositions for an FPC according to the embodiment (Examples 1 to 9) may provide high adhesiveness and solder reflow resistance even if a base film having low dielectric properties is used, and attain excellent electrical properties.

### Production of Coverlay Film

The resin composition for an FPC was applied to each of various base films, and cured and dried to a semi-curing state (B-stage) on the condition of 150° C. and 5 minutes such that the thickness after drying was 25 Thus, coverlay films were obtained.

### Production of Single-Sided Copper-Clad Laminate

The resin composition for an FPC was applied to each of various base films, and cured and dried to a semi-curing state (B-stage) on a constant curing and drying condition (temperature of 150° C., 5 minutes). Next, the resin composition coated surface was bonded to the rough surface of a copper foil (rolled or electrodeposited). The bonded product was heat pressed at 160° C. for 2 hours to obtain a single-sided copper-clad laminate. Production of Double-Sided Copper-Clad Laminate

The resin composition for an FPC was applied to both surfaces of each of various base films, and cured and dried to a semi-curing state (B-stage) on a constant curing and drying condition (temperature of 150° C., 5 minutes). Next, the resin composition coated surfaces were bonded to rough surfaces of a copper foil (rolled or electrodeposited), respectively. The bonded product was heat pressed at 160° C. for 2 hours to obtain a double-sided copper-clad laminate.

### Production of Copper Foil Comprising Resin

The resin composition for an FPC was applied to a copper foil, and cured and dried to a semi-curing state (B-stage) on a constant curing and drying condition (temperature of 150° C., 5 minutes). Thus, a resin coated copper foil was obtained.

### Production of Bonding Sheet

The resin composition for an FPC was applied to the releasing-treated surface of the releasing-treated PET film, and cured and dried to a semi-curing state (B-stage) on a constant curing and drying condition (temperature of 150° C., 5 minutes). Thus, a bonding sheet was obtained.

The invention provides a resin composition for a flexible printed circuit board that may provide high adhesiveness even if a base film having low dielectric properties is used, and attains excellent electrical properties.

What is claimed is:

1. An adhesive material comprising:
a resin composition, wherein the resin composition comprises a fluororesin, an isocyanate compound, and a dicyclopentadiene epoxy resin; and
an organic filler and/or an inorganic filler;
wherein the fluororesin has a fluorine content of 1 to 50% by mass, and a hydroxyl equivalent according to JIS K 1557-1 of 300 to 5500 g/equivalent; and a carboxyl equivalent according to JIS K 1557-1 of the fluororesin is 1400 g/equivalent or more.

2. The adhesive material according to claim 1, wherein the fluororesin has a weight average molecular weight of 5,000 to 150,000.

3. The adhesive material according to claim 1, wherein the fluororesin has a fluorine content of 3 to 45% by mass, and a hydroxyl equivalent according to JIS K 1557-1 of 450 to 3500 g/equivalent.

4. The adhesive material according to claim 1, wherein the isocyanate compound is one or more selected from the group consisting of xylylene diisocyanate, naphthalene diisocyanate, polyisocyanate, and a blocked isocyanate containing these isocyanates.

5. The adhesive material according to claim 1, wherein the isocyanate compound contains 0.05 to 2.5 isocyanate groups based on one hydroxyl group in the fluororesin.

6. The adhesive material according to claim 1, wherein the epoxy resin contains 0.1 to 10 epoxy groups based on one carboxyl group in the fluororesin.

7. The coverlay film according to claim 1, wherein a content of the organic filler and/or inorganic filler is more than 0 and at most 100 parts by mass based on 100 parts by mass of the fluororesin.

8. The adhesive material according to claim 1, further comprising the organic filler and the inorganic filler, and wherein the organic filler is one or more selected from the group consisting of organic phosphorus compounds, phosphazene compounds, and melamine, and the inorganic filler is one or more selected from the group consisting of aluminum hydroxide, magnesium hydroxide, and silica.

9. A coverlay film, comprising:
an adhesive layer consisting essentially of the adhesive material according to claim 1; and
a base film,
wherein the adhesive layer and the base film are laminated; and
wherein the coverlay film has a dielectric constant less than 3.0 and a dielectric loss tangent less than 0.015.

10. The coverlay film according to claim 9, wherein the base film contains one or more resins comprising liquid crystal polymers.

11. The coverlay film according to claim 9, wherein the base film contains one or more resins comprising polyphenylene sulfide.

12. The coverlay film according to claim 9, wherein the base film contains one or more resins comprising syndiotactic polystyrene.

13. A copper-clad laminate comprising:
an adhesive layer consisting essentially of the adhesive material according to claim 1;
a base film; and
a copper foil,
wherein the base film is laminated on a first surface of the adhesive layer, and the copper foil is laminated on a second surface of the adhesive layer; and
wherein the laminated adhesive layer and base film have a dielectric constant less than 3.0 and a dielectric loss tangent less than 0.015.

14. The copper-clad laminate according to claim 13, wherein the base film contains one or more resins selected from the group consisting of liquid crystal polymers, polyphenylene sulfide, and syndiotactic polystyrene.

15. The copper-clad laminate according to claim 13, wherein the base film contains one or more resins comprising polyphenylene sulfide.

16. The copper-clad laminate according to claim 13, wherein the base film contains one or more resins comprising syndiotactic polystyrene.

17. The copper clad laminate according to claim 13, which is a double-sided copper-clad laminate, further comprising:
a second adhesive layer laminated on a surface of the base film opposite the first adhesive layer; and
a second copper foil laminated on a surface of the second adhesive layer opposite to the surface of the second adhesive layer on which the base film is laminated;
wherein the second adhesive layer comprises:
a resin composition, wherein the resin composition comprises a fluororesin, an isocyanate compound, and a dicyclopentadiene epoxy resin; and
an organic filler and/or an inorganic filler;
wherein the fluororesin has a fluorine content of 1 to 50% by mass, and a hydroxyl equivalent according to JIS K 1557-1 of 300 to 5500 g/equivalent; and a carboxyl equivalent according to JIS K 1557-1 of the fluororesin is 1400 g/equivalent or more.
